(19) United States
(12) Patent Application Publication
(10) Pub. No.: US 2014/0323363 A1
(43) Pub. Date: Oct. 30, 2014

(54) NANOTRACERS FOR LABELING OIL FIELD INJECTION WATERS

(71) Applicants: Pascal Perriat, Lyon (FR); Nicolas Crowther, Saint-Quentin-Fallavier (FR); Matteo Martini, Lyon (FR); Olivier Tillement, Fontaines Saint Martin (FR); Thomas Brichart, Lyon (FR); Nicolas Agenet, Pau (FR)

(72) Inventors: Pascal Perriat, Lyon (FR); Nicolas Crowther, Saint-Quentin-Fallavier (FR); Matteo Martini, Lyon (FR); Olivier Tillement, Fontaines Saint Martin (FR); Thomas Brichart, Lyon (FR); Nicolas Agenet, Pau (FR)

(73) Assignee: TOTAL SA, Courbevoie (FR)

(21) Appl. No.: 14/128,194

(22) PCT Filed: Jun. 22, 2012
(86) PCT No.: PCT/EP2012/062075

§ 371 Date: Jul. 16, 2014

(30) Foreign Application Priority Data
Jun. 22, 2011 (FR) 11 55513

(51) Int. Cl. C09K 8/588

(52) U.S. Cl. CPC C09K 8/588
USPC 507/219

(57) ABSTRACT

This invention relates to the development of nanoparticles, which can be used as tracers, in order to track the movement of fluids injected into an oil reservoir. The injected fluids diffuse through a solid geological medium which constitutes the oil reservoir, thus making it possible to study this latter by following the path of the injected fluids. The objective is in particular to monitor the flows between the injection well(s) and the production well(s) and/or to evaluate the volumes of oil in reserve and water in the reservoir and ultimately to optimize oil exploration and exploitation.

### PRIORITY CLAIM

The present application is a National Phase entry of PCT Application No. PCT/EP2012/062075, filed Jun. 22, 2012, which claims priority from French Patent Application No. 11 55513, filed Jun. 22, 2011, said applications being hereby incorporated by reference herein in their entirety.

### FIELD OF THE INVENTION

The field of this invention is that of exploration and exploitation of oil reservoirs. More precisely, this invention relates to the development of nanoparticles which can be used as tracers in order to follow the movement of fluids injected into an oil reservoir.

The injected fluids diffuse through a solid geological medium which constitutes the oil reservoir, thus making it possible to study this latter by following the path of the injected fluids. The objective is in particular to monitor the flows between the injection well(s) and the production well(s) and/or to evaluate the volumes of oil in reserve and water in the reservoir and ultimately to optimize oil exploration and exploitation.

### BACKGROUND OF THE INVENTION

In the exploitation of an oil reservoir it is well known that most often no more than half, or even less, of the oil originally present in the reservoir is extracted. The recovery by the primary means, that is to say the use of the extraction energy resulting from gases or liquids present underground under the effect of a certain pressure in the reservoir only makes it possible to extract small percentages of the total oil present in the reservoir. In order to complete this primary recovery, a secondary recovery is performed: it consists of implementing what is known as production by “water drive” or “water flooding”, i.e. by injecting water into a well (injection well) at a location of the reservoir in such a way as to drive the oil in the reservoir out of the underground area through at least one other well referred to as the “production well”.

In order to be aware of the behavior of the injection water, it is known to add tracers to it which are easily detectable in the liquid. These tracers make it possible to track the injection water. The measurement of the quantity of tracer at the level of the production well makes it possible to know the volume and the distribution of the injection fluid in the formation. Furthermore, the tracer/oil interaction can enable determination of the proportion of liquids in the deposit constituted by the oil reservoir. This is one of the most important parameters which can be determined by the use of such tracing fluids, since this parameter makes it possible, on the one hand, to adjust the water injection program and, on the other hand, to evaluate the quantity of oil still to be produced. As soon as the fluid containing the tracer has been detected at the production well(s), the study method enabling the analysis, control and optimized recovery of oil makes it necessary for the concentration of tracer in the fluid produced at the outlet to be measured continuously or intermittently, in such a way that tracer concentration curves can be plotted as a function of time or as a function of the volume of fluid produced.

The tracers in the injection water for oil reservoirs also enable detection of aberrations in the flow rates caused by of pressure differentials in the reservoir which are caused by factors other than the injection of water and which impair the performance.

The specification of tracers which can be used in these injection waters for optimization of the recovery of oil comprises the following details:
economical;
compatible with the fluids naturally present in the reservoir, and with oil-bearing rock itself and also with the fluids injected into the reservoir, namely the injection liquids (waters);
easy qualitative and quantitative detection of the tracer regardless of the materials present in the fluid at the outlet of the production well. For example, an aqueous solution of sodium chloride cannot be used as tracer because the majority of oil fields contain sea water and therefore sodium chloride in substantial quantities, so that the detection of chloride of NaCl used as tracer would be particularly difficult;
surreptitious tracer, that is to say it cannot be easily absorbed in the solid medium through which it passes or eliminated from the tracing fluid, since in the analytical technique used, the tracer concentration in the fluids produced at the outlet is determined and compared with the concentration of fluids injected in the injection well(s);
resistance of the tracer to bacterial contamination, to the high temperatures and high pressures existing in the oil reservoirs;
offers the possibility of the tracer interacting or not with the environment of the reservoir, namely the geological media which may or may not be oil-bearing;
access for a large number of different tracers and coding for possible simultaneous detections (several injection wells) or chronologically successive tracing tests.

With regard to the prior art relating to such tracers for injection waters (tracing fluid) enabling surveying of the oil reservoirs by diffusion between an injection well and a production well, reference may be made to the U.S. Pat. No. 4,231,426 B1 and U.S. Pat. No. 4,299,709 B1 which disclose aqueous tracer fluids comprising from 0.01 to 10% by weight of a nitrate salt associated with a bactericidal agent chosen from among the aromatic compounds (benzene, toluene, xylene).

Canadian Patent Application CA 2 674 127 A1 relates to a method which uses a natural isotope of carbon 13 for the identification of early breakthrough of the injection waters into the oil well.

Moreover, there are about ten families of appropriate molecules currently validated as tracer for injection waters in oil reservoirs. These families of molecules are for example fluorinated benzoic acids or naphthalenesulphonic acids.

The known tracer molecules which are used have a specific chemical/radioactive signature. These known tracers can be detected with great sensitivity but nevertheless have three major drawbacks:
quantification thereof requires a process which is quite complex and expensive, and can only be carried out in a specialist center, often remote from the production sites;
These molecules are not very numerous and do not enable multi-labelling or repeated labelling to be effected;
some of these known markers are destined to disappear because of their negative impact on the environment.

Moreover, the site of “Institute for Energy Technology” (IFE) has put online a PowerPoint presentation entitled SIP 2007-2009 “New functional tracers based on nanotechnology and radiotracer generators Department for Reservoir and Exploration Technology” (last modification dated 7 Mar. 2011). In particular, this document suggests the use of surface-modified nanoparticles as tracer for monitoring flows in oil reservoirs and oil wells and in studies of processes. This presentation describes functionalized tracer nanoparticles comprising a core based on Gd₂O₃ and a surface coating based on siloxane functionalised with additional molecules. It is also suggested that the rare earth core and/or the additional molecules can emit luminous signals by fluorescence or radioactive signals.

In a quite different field, the French Patent Application FR 28 67 180 A1 describes hybrid nanoparticles comprising, on the one hand, a core consisting of a rare earth oxide, possibly doped with a rare earth or an actinide or a mixture of rare earths and actinide and, on the other hand, a coating around this core, the said coating consisting predominantly of polysiloxane functionalised by at least one biological ligand grafted by covalent bond. The core may be based on Gd₂O₃ doped with Tb³⁺ or by uranium and the coating of polysiloxane can be obtained by causing an aminopropyltriethoxysilane, a tetraethylsilicate and triethylamine to react. These nanoparticles are used as probes for the detection, the monitoring and the quantification of biological systems.

French Patent Application FR 29 22 106 A1 derives from the same technical field and relates to the use of these nanoparticles as radiosensitizing agents in order to increase the effectiveness of radiotherapy. These nanoparticles have a size between 10 and 50 nanometers.

### SUMMARY OF THE INVENTION

In this context the object of the present invention is to address at least one of the following objectives:
to propose a novel method of studying a solid medium, for example an oil reservoir, by diffusion of a liquid through said solid medium, which is simple to implement and economical;
to remedy the drawbacks of tracers for injection waters of oil reservoirs according to the prior art;
to provide a tracer which perfectly follows the injection waters in their diffusion (percolation) through the solid media constituted by the oil reservoirs, without interacting with the geological underground area through which it passes (neither attraction nor repulsion);
to provide a tracer for injection waters of oil reservoirs of which the interactions (attraction-repulsion) in the relation to the geological medium through which it percolates can be monitored intentionally;
to provide a novel surreptitious tracer for injection waters of oil reservoirs;
to provide a novel tracer for injection waters of oil reservoirs having a sensitivity and/or facility for detection substantially improved relative to the tracers known until now;
to provide a novel tracer for injection waters for oil reservoirs having several easily detectable signals in order to produce multi-detection and multiply the analyses over the course of time or space;
to provide a novel and co-compatible tracer for injection waters of oil reservoirs;
to provide a novel tracer for injection waters of oil reservoirs which is physically, chemically and biologically stable in the geological solid media constituted by the oil reservoirs;
to provide a novel liquid, in particular novel injection waters, of oil reservoirs which can be used in particular in a process for studying a solid medium, for example an oil reservoir by diffusion of said liquid through said solid medium;
to provide a novel process for synthesis for such tracers which is simple and economical to implement.

These objectives, amongst others, are achieved by the invention which relates in the first place to nanoparticles for use in the study of an oil reservoir, said nanoparticles being characterized in that they comprise:
a core consisting of a noble metal or an alloy of noble metals,
a matrix comprising (i) polysiloxanes and (ii) an organometallic fluorophore bound covalently to the polysiloxanes, said matrix being functionalized on its surface in order to form silane bonds Si—R, wherein preferably at least 50%, preferably at least 75% of said radicals —R consist of neutral or charged hydrophilic compounds, preferably from amongst polyethers or polyols, or mixtures thereof.

The invention relates secondly to a method of preparation of a colloidal solution of nanoparticles which can be used for the study of an oil reservoir, said method comprising the following steps:
i. a noble metal core is synthesized and is coated with a matrix of polysiloxane prefunctionalized with hydrophilic silanes, within a reverse microemeulsion,
ii. an aqueous colloidal solution of nanoparticles is extracted by decantation after destabilization of the microemulsion, for example in a water/alcohol mixture,
iii. the nanoparticles are heated to at least 50° C., for example approximately 80° C.

Thirdly, the invention relates to an injection liquid for the study of an oil reservoir, comprising nanoparticles as defined above, or a colloidal solution of nanoparticles capable of being obtained by the method as defined above.

The invention also concerns the use of these nanoparticles as tracers in injection waters of an oil reservoir, which are intended for the study of said reservoir by diffusion therethrough, for the purpose in particular of controlling the flows between an injection well and a production well and/or evaluating the volumes of oil in reserve in the reservoir.

### BRIEF DESCRIPTION OF THE DRAWINGS

FIG. 1 shows the time-resolved emission spectrum (delay 0.1 ms, acquisition time 5 ms) of the nanoparticles containing Eu DTPA and fluorescein excited to 395 nm and the time-resolved excitation spectrum (delay 0.1 ms, acquisition time 5 ms) of these same nanoparticles with an emission fixed at 615 nm

FIG. 2 shows the time-resolved emission spectrum (delay 0.1 ms, acquisition time 5 ms) of the nanoparticles containing Eu DTPA and fluorescein excited to 615 nm and the time-resolved excitation spectrum (delay 0.1 ms, acquisition time 5 ms) of these same nanoparticles with an emission fixed at 395 nm

FIG. 3a shows the the time-resolved excitation spectrum (delay 0.1 ms, acquisition time 5 ms) of the particles containing the nanoparticles containing Tb and derivatives of pyridine with an emission fixed at 545 nm

FIG. 3b shows the the time-resolved emission spectrum (delay 0.1 ms, acquisition time 5 ms) of the particles containing the nanoparticles containing Tb and derivatives of pyridine excited to 246 nm

FIG. 4 shows comparative permeation curves between a reference tracer (grey) and the nanoparticles (black) according to the method of preparation 4. In the X axes, the flow volume In the Y axes, the absorption or the fluorescence, standardized to the initial values.

After 180 mL, a solution of degassed sea water without tracers is injected.

### DETAILED DESCRIPTION OF THE INVENTION

The Nanoparticles

The nanoparticles according to the invention are intended for use in the study of an oil reservoir, said nanoparticles being characterized in that they comprise:
a core consisting essentially of a noble metal or an alloy of noble metals,
a matrix comprising (i) polysiloxanes and (ii) an organometallic fluorophore bound covalently to the polysiloxanes, said matrix being functionalised on its surface in order to form silane bonds Si—R, wherein preferably at least 50%, preferably at least 75% of said radicals —R consist of neutral or charged hydrophilic compounds, preferably from amongst polyethers or polyols, or mixtures thereof.

The nanoparticles according to the invention are detectable, that is to say that it is possible to identify their presence or absence in the medium above a certain concentration and that it is even possible to quantify the concentration thereof when they are present in the medium.

These nanoparticles are capable of forming a stable colloidal suspension in a saline medium which does not settle very much. For example, this suspension does not exhibit precipitation or agglomeration over time, e.g. after 6 months at ambient temperature.

The core of nanoparticles makes it possible to structure the nanoparticle. According to the present invention the core consists essentially of a noble metal, for example gold, silver or platinum, and/or an alloy of noble metals. In a preferred embodiment the core essentially consists of particles of gold.

In fact it has been found, surprisingly, that the nanoparticles obtained according to the invention are more dense and of more regular structure than those carried out with other materials for the choice of the core. Furthermore, in certain cases gold has an antenna effect which then makes it possible advantageously to amplify the fluorescent signal emitted by the organometallic fluorophore of the matrix during detection.

Gold, with other noble metals such as Ag, Pd, Pt, Ir, or Rh, is also detectable by the ICP detection method (or plasma torch spectrometry) and can be used as internal reference for the detection of nanoparticles and any degradation thereof.

Finally, gold has the advantage that it is also detectable by plasmon absorption enabling the detection and the quantification of nanoparticles at very low concentrations, for example at the level of the single particle, in particular after dispersion of a given volume on a substrate. A particle can be detected in 10 μL at least, preferably 100 μL.

The gold particles forming the core of nanoparticles have a size of at least 3 nm, preferably between 5 nm and 15 nm.

The matrix forms a layer coating the core of noble metals of the nanoparticle. It makes it possible to encapsulate the detectable molecules for the detection and/or the quantification of nanoparticles.

The matrix of nanoparticles according to the invention comprises polysiloxanes and at least one organometallic fluorophore bound covalently to the polysiloxanes. In a specific embodiment, said matrix consists essentially of polysiloxane, functionalised on the exterior surface of the nanoparticles and encapsulating organometallic fluorophores.

The matrix/core assembly forms nanoparticles having a mean diameter preferably between 20 nm and 100 nm, for example between 20 nm and 50 nm. In an advantageous embodiment the nanoparticles according to the invention have a polydispersity index of less than 0.5, preferably less than 0.3, or less than 0.2, preferably less than 0.1.

The size distribution of the nanoparticles is for example measured with the aid of a commercial granulometer such as a Malvern Zetasizer Nano-S granulometer based on PCS (Photon Correlation Spectroscopy). This distribution is characterized by a mean diameter and a polydispersity index.

Within the meaning of the invention, “mean diameter” is understood to mean the harmonic mean of the diameters of the particles. The polydispersity index makes reference to the width of the size distribution deriving from the analysis of the cumulants. These two characteristics are described in the Standard ISO 13321:1996.

If applicable, the matrix may comprise other materials, chosen from within the group consisting of silicas, aluminas, zircons, aluminates, aluminophosphates, metal oxides or also metals (example: Fe, Cu, Ni, Co . . . ) passivated on the surface by a layer of the oxidized metal or another oxide and mixtures and alloys thereof.

An essential function of the matrix is to maintain the organometallic fluorophores in the nanoparticles and in particular to protect them from attacks from the external environment.

The organometallic fluorophores make it possible to produce one or more detectable signals per nanoparticle. The organometallic fluorophores used in the nanoparticles according to the invention are preferably chosen in such a way as to produce a fluorescent signal which is stable in time and which is not significantly influenced by the physico-chemical conditions of the environment through which they pass (for example temperatures, pH, ionic compositions, solvents, redox conditions . . . )

The organometallic fluorophores contained in the matrix of the nanoparticles are chosen from among vanadates or rare earth oxides, or mixtures thereof. In a specific embodiment they are chosen from among lanthanides, alloys thereof and mixtures thereof, bound to complexing molecules.

In a preferred embodiment the organometallic fluorophores are detectable by time-resolved fluorescence. Then lanthanides bound to complexing molecules are particularly preferred.

The metals of the lanthanide series comprise elements with atomic numbers from 57 (lanthanum) to 71 (lutetium). For example, the lanthanides will be chosen from within the group consisting of: Pr, Nd, Sm, Eu, Tb, Dy, Ho, Er, Tm and Yb and mixtures and/or alloys thereof, bound to complexing molecules.

“Complexing molecules” or “chelating agent” are understood to mean any molecule capable of forming with a metallic agent a complex comprising at least two co-ordination bonds.

In a preferred embodiment, a complexing agent having a co-ordinance of at least 6, for example at least 8, and a dissociation constant of the complex pKd, greater than 10 and preferably greater than 15, with a lanthanide

Within the meaning of the invention, the “dissociation constant pKd” is understood to mean the measurement of the equilibrium between the ions complexed by the ligands and the free ligand dissociated in the solvent. Precisely, it is not so much the base 10 logarithm of the product of dissociation (−log(Kd)), defined as the equilibrium constant of the reaction which expresses the passage from the complexed state to the ionic state.

Such complexing agents are preferably polydentate chelating molecules chosen from amongst the families of molecules of the polyamine type, carboxylic polyacids and those having a high number of potential co-ordination sites preferably greater than 6, such as certain macrocycles.

In a more preferred embodiment, DOTA or 1,4,7,10-tetraazacyclododecane-1,4,7,10-tetraacetic acid of the following formula will be chosen:

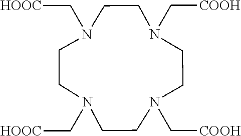 [SMILES: O=C(O)CN1CCN(CC(=O)O)CCN(CC(=O)O)CCN(CC(=O)O)CC1]

or one of the derivatives thereof

The matrix may also contain, in addition to the complexing agent, a cyclic agent, for example grafted to the polysiloxanes.

A “cyclic agent” is understood to be an organic molecule, having at least one aromatic ring or heterocyclic ring, preferably chosen from amongst benzene, pyridine or derivatives thereof and capable of amplifying the fluorescent signal emitted by the organometallic fluorophore, for example a complexing agent bound to lanthanide. These cyclic agents, which are of interest if they are characterized by a high absorbance, are used in particular to amplify the fluorescent signal emitted by the organometallic fluorophores (antenna effect by transfer of the excitation of the agent to the fluorophore).

The cyclic agent can be grafted covalently either directly to the polysiloxanes of the matrix or to the organometallic fluorophore.

In a specific embodiment, the organometallic fluorophores consisting of a lanthanide with a complexing agent are grafted covalently to the polysiloxanes via an amide function.

The matrix of the nanoparticles according to the invention is functionalised on its surface. The functionalization of the matrix comprises the formation of silane bonds Si—R, wherein preferably at least 50%, preferably at least 75% of said radicals —R consist of neutral or charged hydrophilic compounds, preferably from amongst polyethers or polyols, or mixtures thereof.

In a preferred embodiment the functionalization of the nanoparticles is carried out in such a way that the zeta potential of the nanoparticles measured at a pH of 6.5 is less than +10 mV.

Within the meaning of the invention, the term “zeta potential” refers to the electrokinetic potential in the colloidal systems. This is the electrical potential of the double surface layer or also the difference in potential between the solvent and the layer of liquid attached to the particle. The zeta potential can be measured with the same apparatus as that used in order to measure the size distribution as described in the article “zeta potential of colloids in Water”, ASTM Standard D 4187-82, American Society for Testing and Materials, 1985.

The objective of functionalization is in particular to obtain good colloidal stability in a saline medium, for example a critical salt concentration of at least 50 g/L, even at least 100 g/L. It also has the function of modulating the water/rock interactions of the nanoparticle (minimizing adsorption thereof on the rock for example), even of modulating (for example minimizing) the water/oil interactions.

Such interactions can be measured during an experiment of permeation on a core as described in the examples below. According to a preferred embodiment, the nanoparticles according to the invention exhibit a minimal adsorption with this type of test.

The radicals —R covalently grafted on the basis of silane bonds Si—R may comprise:
i. charged hydrophilic groups, preferably hydrophilic organic compounds, molar masses below 5000 g/mol and more preferably below 450 g/mol, preferably chosen from among the organic groups including at least one of the following functions: alcohol, carboxylic acid, amine, amide, ester, ether oxide, sulphonate, phosphonate and phosphinate, and a combination of these functions,
ii. neutral hydrophilic groups, preferably chosen from among sulphonate derivatives, alcohols, for example sugars or polyols, more preferably a polyalkylene glycol or a polyol, even more preferably a polyethylene glycol, Diethylene Triamine PentaAcetic acid (DTPA), dithiolated DTPA (DTDTPA), a gluconamide or a succinic acid, and mixtures of these neutral hydrophilic groups,
iii. if appropriate, hydrophobic groups, for example chosen from among molecules containing alkyl or fluorinated chains.

According to one embodiment of the invention, at least 50%, preferably at least 75%, of the radicals —R of the silanes Si—R on the surface consist of neutral hydrophilic radicals, for example chosen from among polyols, for example gluconamide, or polyethers, for example polyethylene glycol, or mixtures thereof.

Advantageously, the —R radicals of the silane bonds are present on the surface in a proportion of at least one radical —R per 10 nm² of surface, for example at least one radical —R per 1 nm², and preferably at least between 1 and 10 radicals —R per nm².

The surface functionalization is effected by condensation of silanes on the surface of the matrix. It is also possible to add polysilanes (such as diethylene-di(trimethoxy)silane) during the condensation in order to passivate the surface of the coating and to ensure good adhesion thereof

### Method for Preparation of a Colloidal Suspension of Nanoparticles

The invention relates to a method for preparation of a colloidal suspension of nanoparticles which can be used as tracer for the study of an oil reservoir.

The method according to the invention comprises the following steps:
a noble metal core is synthesized and is coated with a matrix of polysiloxane prefunctionalized with hydrophilic silanes, within a reverse microemeulsion,
an aqueous colloidal solution of nanoparticles is extracted by decantation after destabilization of the microemulsion, for example in a water/alcohol mixture, for example water/isopropanol,
the nanoparticles are heated to at least 50° C., for example approximately 80° C.

More precisely, according to the method according to the invention the core and the matrix are synthesised in reverse microemeulsion. It is possible, if applicable, to pre-coat the nanoparticles at this stage with a hydrophilic silane.

The microemulsion is then destabilized, for example with a water/alcohol mixture such as water/isopropanol, in such a way as to extract the nanoparticles in the form of a stable colloidal aqueous solution (i.e. which is not precipitated). Furthermore, the solution extracted by decantation can be washed for example by tangential filtration. Thus in an advantageous embodiment of the method according to the invention the nanoparticles are never in a dry phase.

The method without a dry solid phase would make it possible to obtain nanoparticles of more homogeneous size, and therefore with a lower polydispersity index.

Another particularly advantageous step of the method according to the invention is the step of heating, to at least 50° C., for example at least 60° C., at least 70° C., for example to 80° C., for a sufficient time to enable densification of the coating layer, for example at least 30 minutes, preferably at least 1 hour. The step of heating makes it possible to increase the stability of particles, in particular in time, by limiting the agglomeration phenomena. This would also make it possible to densify the coating and to reduce the number of free silanol groups on the surface and more generally in the coating layer. Thus the adhesion and the stability of the coating layer are improved and would also enable additional protection of the fluorophores contained in the matrix.

Therefore the method according to the invention makes it possible to obtain colloidal solutions with nanoparticles having advantageous properties and distinct from the prior art, in particular with a smaller mean diameter, for example less than 50 nm and a low polydispersity index, for example less than 0.3, even less than 0.1, and with a very low reactivity with the external environment (surreptitious tracer), as can be demonstrated with the aid of the permeation test described in the example.

The invention also relates to a colloidal solution of nanoparticles which can be obtained according to the method of the invention described above.

Even more preferably, the nanoparticles are prepared as claimed in the method above and have the advantageous structural characteristics as defined above. In particular, the nanoparticles obtained by the above method comprise a core of noble metal, for example of gold, and a matrix comprising polysiloxanes including an organometallic fluorophore, for example a complexing agent bound to a lanthanide.

### Methodology

The nanoparticles according to the invention are particularly useful as tracers in injection waters of an oil reservoir, which are intended for the study of said reservoir by diffusion therethrough, for the purpose in particular of monitoring the flows between an injection well and a production well and/or evaluating the volumes of oil in reserve in the reservoir.

Before the analysis of the liquid which has diffused, said liquid is concentrated, preferably by filtration or dialysis, and, even more preferably, by tangential filtration and preferably by use of a membrane with cut-off thresholds below 300 kDa (kilo Dalton).

Preferably, it will be desirable to detect at least two types of signals emitted by the nanoparticles:
a first signal capable of being emitted by the organometallic fluorophores and measured by fluorescence.
and a second signal capable of being emitted by the noble metal (such as gold, silver, platinum and mixtures and/or alloys thereof), and measured by chemical analysis and/or by ICP;
said noble metal constituting the core of the nanoparticle.

In a preferred embodiment, in order to measure the quantity of nanoparticles in the liquid which has diffused, detection is carried out by time-resolved fluorescence (in order to detect the organometallic fluorophores) and/or by ICP (for the detection of the noble metal in the core of the nanoparticles).

The method of detection by time-resolved fluorescence is for example described in the article “ultrasensitive bioanalytical assays using time resolved fluorescence detection”, Phnrmac. Thu. Vol. 66, pp. 207-335, 21995. The method of detection by ICP is for example described in “application of laser ICP-MS in environmental analysis”, Fresenieus date of Analytical Chemistry, 355: 900-903 (1996).

Detection by time-resolved fluorescence, i.e. activated with a time lag after excitation (i.e. several microseconds) makes it possible to eliminate a large part of the intrinsic luminescence in the solid medium studied and to measure only the intrinsic luminescence relative to the tracing nanoparticle.

### Injection Liquid (Water) for the Study of a Solid Medium, Namely i.e. an Oil Reservoir

According to another aspect, the invention relates to a liquid for injection in an oil reservoir, characterized in that it comprises a tracer based on nanoparticles according to the invention as defined above.

Advantageously, this liquid comprises water and the nanoparticles as defined above.

The injection waters may comprise, in addition to the nanoparticles, the following elements: surfactants, small hydrophilic polymers, polyalcohols (for example diethylene glycol), salts and other molecules conventionally used in oil injection.

### Examples

Method of Preparation 1. Preparation of a Colloidal Solution of Nanoparticles with a Core of Gold and a Silica Matrix Encapsulating Organic Fluorophores Derived from Fluorescein and Europium Complexes (DTPA)

200 mg of diethylenetriaminepentaacetic acid bisanhydride (DTPABA), 0.130 mL of APTES and 0.0065 mL of triethylamine are introduced with 4 mL of DMSO (dimethyl sulfoxide) into a 10 mL bottle and stirred vigorously. After 24 hours, 200 mg of EuCl₃,6H₂O are added. After i48 hours the complexing is sufficient; the following steps are then carried out: 20 mg of FITC (fluorescein isothiocyanate) are introduced with 0.5 mL of APTES ((3-aminopropyl)triethoxysilane) into a 2.5 mL bottle and stirred vigorously. Homogenization is carried out for 30 minutes at ambient temperature.

36 mL of Triton X-100 (surfactant), 36 mL of n-hexanol (co-surfactant), 150 mL of cyclohexane (oil) and 21 mL of aqueous solution containing 9 mL of HAuCl 3H₂O at 16.7 mM, 9 mL of MES (sodium 2-mercaptoethanesulphonate) at 32.8 mM and 3 mL of NaBH₄ at 412 mM are introduced into a 500 mL flask and stirred vigorously. After 5 minutes, 0.400 mL of solution containing fluorescein is added into the microemulsion with 1 mL of the solution containing the europium complex. Then 0.200 mL of APTES and 1.5 mL of TEOS (tetraethyl orthosolicate) are also added to the microemulsion.

The polymerization reaction of the silica is completed by the addition of 0.800 mL of NH₄OH after 10 minutes. The microemulsion is stirred for 24 hours at ambient temperature.

Next, 190 μL of silane gluconamide (N-(3-triethoxysilylpropyl)gluconamide at 50% in ethanol is added to the microemulsion and stirred at ambient temperature.

After 24 hours, 190 μL of silane gluconamide are again added to the solution and stirring is continued at ambient temperature.

After 24 hours, the microemulsion is destabilized in an ampoule for decanting by addition of a mixture of 250 mL of distilled water and 250 mL of isopropanol. The solution is left to decant for 15 minutes and the lower phase containing the particles is recovered.

The recovered colloidal solution is then placed in a tangential filtration system VIVASPIN® at 300 kDa then centrifuged at 4000 r.p.m. until a purification rate greater than 500 is obtained.

The solution thus obtained is then filtered at 0.2 μm and diluted by 5 in DEG (diethyleneglycol).

Method of Preparation 2. Preparation of a Colloidal Solution of Nanoparticles with a Core of Gold and a Silica Matrix Encapsulating Organic Fluorophores Derived from Fluorescein and Europium Complexes (DOTA).

The synthesis is similar to that described in the method of preparation 1 with the difference that the 200 mg of diethylenetriaminepentaacetic acid bisanhydride are replaced by 256 mg of 1,4,7,10-tetraazacyclododecane-1,4,5,10-tetraacetic glutaric anhydride (DOTAGA). The rest of the synthesis is identical.

Method of Preparation 3. Preparation of a Colloidal Solution of Nanoparticles with a Core of Gold and a Silica Matrix Encapsulating Organic Molecules Containing an Aromatic Ring which are Derived from Pyridine (Antenna) and Terbium Complexes.

85 mg de 2-pyridinethioamide (antenna), 70 mg de NHS (N-hydroxysuccinimide) and 230 mg of EDC (ethyl(dimethylaminopropyl)carbodiimide) are introduced with 2 mL of DMSO (dimethyl sulfoxide) into a 2.5 mL bottle and stirred vigorously. After 30 minutes, 140 μL of APTES are added and the mixture is left for 5 hours.

Next, 1 batch of freeze-dried terbium oxide nanoparticles (diameter 5 nm) purchased from Nano-H SAS are re-dispersed in 2 mL of distilled water in a 2.5 mL bottle.

36 mL of Triton X-100 (surfactant), 36 mL of n-hexanol (co-surfactant), 150 mL of cyclohexane (oil) and 21 mL of aqueous solution containing 9 mL of HAuCl₄ 3H2O at 16.7 mM, 9 mL of MES (sodium 2-mercaptoethanesulphonate) at 32.8 mM and 3 mL of NaBH₄ at 412 mM are introduced into a 500 mL flask and stirred vigorously. After 5 minutes, 0.600 mL of solution containing the antennas is added into the microemulsion with 2 mL of the solution containing the terbium particles. Then 0.550 mL of APTES and 1.5 mL of TEOS (tetraethyl orthosolicate) are also added to the microemulsion.

The polymerization reaction of the silica is completed by the addition of 0.800 mL of NH₄OH after 10 minutes. The microemulsion is stirred for 24 hours at ambient temperature.

The functionalization with the silane-gluconamide and the treatment of the microemulsion are as described for the method of preparation 1.

Method of Preparation 4. Preparation of a Colloidal Solution of Nanoparticles with a Core of Gold and a Silica Matrix Encapsulating Organic Molecules Containing an Aromatic Ring which are Derived from Fluorescein and Particles Containing Europium Complexes.

20 mg of FITC (fluorescein isothiocyanate) are introduced with 0.5 mL of APTES ((3-aminopropyl)triethoxysilane) into a 2.5 mL bottle and stirred vigorously. Homogenization is carried out for 30 minutes at ambient temperature.

1 batch of freeze-dried SRP-europium nanoparticles (diameter 5 nm-20 micromoles equivalent europium—Small Rigid Platform polysiloxane-DOTA(Eu)) (Nano-H SAS, France) are re-dispersed in 1.5 mL of distilled water in a 2.5 mL bottle.

36 mL of Triton X-100 (surfactant), 36 mL of n-hexanol (co-surfactant), 150 mL of cyclohexane (oil) and 21 mL of aqueous solution containing 9 mL of HAuCl₄ 3H2O at 16.7 mM, 9 mL of MES (sodium 2-mercaptoethanesulphonate) at 32.8 mM and 3 mL of NaBH4 at 412 mM are introduced into a 500 mL flask and stirred vigorously. After 5 minutes, 0.400 mL of solution containing fluorescein is added into the microemulsion with 1.5 mL of the solution containing the europium particles. Following this, 0.200 mL of APTES and 1.5 mL of TEOS (tetraethyl orthosolicate) are also added to the microemulsion.

The polymerization reaction of the silica is completed by the addition of 0.800 mL of NH4OH after 10 minutes. The microemulsion is stirred for 24 hours at ambient temperature.

The functionalization with the silane-gluconamide and the treatment of the microemulsion are as described for the method of preparation 1.

Method of Preparation 5a. Preparation of a Colloidal Solution of Nanoparticles with a Core of Gold and a Silica Matrix Encapsulating Organic Molecules Containing an Aromatic Ring of Pyridine and Particles Containing Europium Complexes.

The synthesis is similar to that described in the method of preparation 1 with the difference of the functionalization effected in the microemulsion. The second addition of 190 mL of silane-gluconamide is replaced by an addition of 450 mg of silane (N-triethoxysilylpropyl)-O-polyethylene oxide urethane) corresponding to a theoretical quantity of 2 silanes per nm² of surface.

Method of Preparation 5b. Preparation of a Colloidal Solution of Nanoparticles with a Core of Gold and a Silica Matrix Encapsulating Organic Molecules Containing an Aromatic Ring of Pyridine and Particles Containing Europium Complexes.

The synthesis is similar to that described in the method of preparation 1 with the difference of the functionalization effected in the microemulsion. The second addition of 190 mL of silane-gluconamide is replaced by an addition of 340 μL of silane ([hydroxy(polyethylenoxy)propyl]triethoxysilane) at 50% in ethanol, corresponding to theoretical quantity of 2 silanes per nm² of surface.

Method of Preparation 5c. Preparation of a Colloidal Solution of Nanoparticles with a Core of Gold and a Silica Matrix Encapsulating Organic Molecules Containing an Aromatic Ring of Pyridine and Particles Containing Europium Complexes.

The synthesis is similar to that described in the method of preparation 1 with the difference of the functionalization effected in the microemulsion. The second addition of 190 mL of silane-gluconamide is replaced by an addition of 185 μL of silane (N-(trimethoxysilylpropyl)ethylenediaminetriacetic acid) at 45% in water, corresponding to a theoretical quantity of 2 silanes per nm² of surface.

Method of Preparation 5d. Preparation of a Colloidal Solution of Nanoparticles with a Core of Gold and a Silica Matrix Encapsulating Organic Molecules Containing an Aromatic Ring of Pyridine and Particles Containing Europium Complexes.

The synthesis is similar to that described in the method of preparation 1 with the difference of the functionalization effected in the microemulsion. The second addition of 190 mL of silane-gluconamide is replaced by an addition of 60 μL of silane (3-thiocyanatopropyltriethoxysilane), which corresponds to a theoretical quantity of 2 silanes per nm² of surface.

Method of Preparation 5e. Preparation of a Colloidal Solution of Nanoparticles with a Core of Gold and a Silica Matrix Encapsulating Organic Molecules Containing an Aromatic Ring of Pyridine and Particles Containing Europium Complexes.

The synthesis is similar to that described in the method of preparation 1 with the difference of the functionalization effected in the microemulsion. The second addition of 190 mL of silane-gluconamide is replaced by an addition of 60 μL of silane (3-isocyanatopropyltriethoxysilane), which corresponds to a theoretical quantity of 2 silanes per nm² of surface.

Method of Preparation 6a.

The solution obtained according to the method of preparation 4 is post-functionalised by a silane (N-(2-aminoethyl)-3-aminopropyltriethoxysilane). In a 15 mL bottle 20 μL of silane is diluted in 10 mL of DEG. In a 15 mL bottle 10 μL of the dilute solution of silane (corresponding to a theoretical quantity of 0.1 molecule of silane per nm² of surface of a particle) is added to 10 mL of the solution obtained according to the method of preparation 4, and the solution obtained is stirred at 40° C. for 48 hours.

Method of Preparation 6b.

The solution obtained according to the method of preparation 4 is post-functionalised by a silane (3-(triethoxysilyl)propylsuccinic anhydride). In a 15 mL bottle 20 μL of silane is diluted in 10 mL of DEG. In a 15 mL bottle 10 μL of the dilute solution of silane (corresponding to a theoretical quantity of 0.1 molecule of silane per nm² of surface of a particle) is added to 10 mL of the solution obtained according to the method of preparation 4, and the solution obtained is stirred at 40° C. for 48 hours.

Method of Preparation 6c.

The solution obtained according to Example 4 is post-functionalised by a silane (O-(propargyloxy)-N-(triethoxysilylpropyl)urethane). In a 15 mL bottle 24 μL of silane is diluted in 10 mL of DEG. In a 15 mL bottle 10 μL of the dilute solution of silane (corresponding to a theoretical quantity of 0.1 molecule of silane per nm² of surface of a particle) is added to 10 mL of the solution obtained in Example 4, and the solution obtained is stirred at 40° C. for 48 hours.

Method of Preparation 7. Colloidal Solution of Nanoparticles with a Core of Gold and a Silica Matrix Encapsulating Organic Molecules Containing an Aromatic Ring which are Derived from Pyridine and Europium Complexes (DTPA).

140 mg de antennas (2,2′:6′,2″-terpyridine), 70 mg de NHS (N-hydroxysuccinimide) and 230 mg of EDC (ethyl(dimethylaminopropyl)carbodiimide) are introduced with 2 mL of DMSO (dimethyl sulfoxide) into a 2.5 mL bottle and stirred vigorously. After 30 minutes, 140 μL of APTES are added.

200 mg of diethylene triamine pentaacetic acid (DTPA), 0.130 mL of APTES and 0.065 mL of triethylamine are introduced with 4 mL of DMSO (dimethyl sulfoxide) into a 10 mL bottle and stirred vigorously. After 24 hours, 200 mg of EuCl₃,6H₂O are added. After 48 hours the complexing is sufficient. 36 mL of Triton X-100 (surfactant), 36 mL of n-hexanol (co-surfactant), 150 mL of cyclohexane (oil) and 21 mL of aqueous solution containing 9 mL of HAuCl₄ 3H2₂O at 16.7 mM, 9 mL of MES (sodium 2-mercaptoethanesulphonate) at 32.8 mM and 3 mL of NaBH₄ at 412 mM are introduced into a 500 mL flask and stirred vigorously. After 5 minutes, 0.400 mL of solution containing fluorescein is added into the microemulsion with 1 mL of the solution containing the europium complex. Next, 0.200 mL of APTES and 1.5 mL of TEOS (tetraethyl orthosolicate) are also added to the microemulsion.

The polymerization reaction of the silica is completed by the addition of 0.800 mL of NH₄OH after 10 minutes. The microemulsion is stirred for 24 hours at ambient temperature.

Next, 190 μL of silane gluconamide (N-(3-triethoxysilylpropyl)gluconamide at 50% in ethanol is added to the microemulsion and stirred at ambient temperature.

After 24 hours, 190 μL of silane gluconamide are again added to the solution and stirring is continued at ambient temperature.

After 24 hours, the microemulsion is destabilized in an ampoule for decanting by addition of a mixture of 250 mL of distilled water and 250 mL of isopropanol. The solution is left to decant for 15 minutes and the lower phase containing the particles is recovered.

The recovered colloidal solution is then placed in a filtration system VIVASPIN® at 300 kDa then centrifuged at 4000 r.p.m. until purification rate above 500 is obtained.

The solution thus obtained is then filtered at 0.2 μm and diluted by 5 in DEG (diethyleneglycol).

The solution obtained is then post-functionalised with 3.72 μl of silane (N-(triethyoxysilylpropyl)-O-polyethylene oxide urethane) (corresponding to a theoretical quantity of 0.1 molecule of silane per nm2 of particle) at 40° C. and stirred for 48 hours.

Results

Mean diameter and polydispersity of nanoparticles as claimed in the methods of preparation 1 to 5 (examples 1 to 5).

Colloidal solutions of nanoparticles were prepared according to the methods of preparation 1 to 5 (Examples 1 to 5 respectively).

The following table gives the mean diameter and the polydispersity index of nanoparticles as obtained according to Examples 1 to 5.

| Examples | Mean diameter | Polydispersity |
|---|---|---|
| Example 1 | 50 nm | 0.091 |
| Example 2 | 62 nm | 0.057 |
| Example 3 | 37 nm | 0.060 |
| Example 4 | 41 nm | 0.055 |
| Example 5a | 46 nm | 0.050 |
| Example 5b | 44 nm | 0.109 |
| Example 5c | 55 nm | 0.083 |
| Example 5d | 53 nm | 0.081 |
| Example 5e | 70 nm | 0.109 |

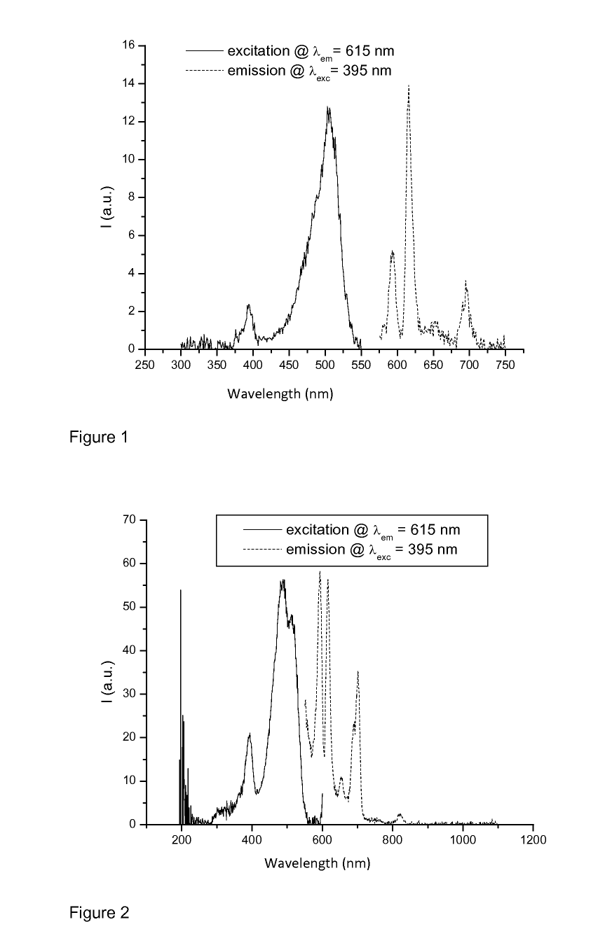

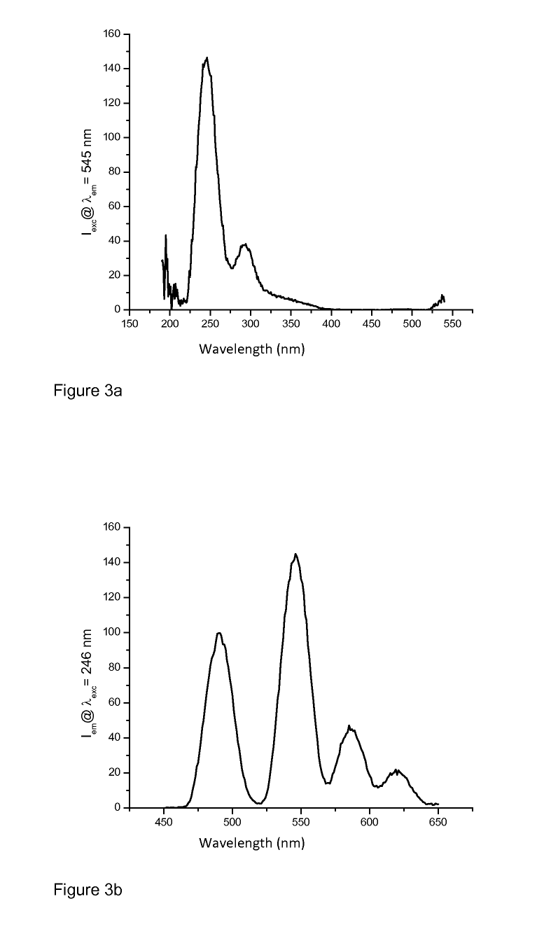

FIGS. 1, 2 and 3 exhibit the excitation and emission spectra with a time lag of 0.1 ms for Examples 1 to 3 respectively. These data show that the nanoparticles exhibit a good property of time-resolved fluorescence.

Comparison of Properties of the Nanoparticles Before and after the Step of Heating

For Examples 6a to 6c, nanoparticles were prepared according to the methods of preparation 6a to 6c.

The following table shows the mean diameter, the polydispersity and the zeta potential of the nanoparticles before and after the step of heating, wherein the step of heating consists of heating the solution of nanoparticles after the post-functionalization at 80° C. for 1 hour and then cooling it at ambient temperature.

| | Values before heating | Values after heating |
|---|---|---|
| | Mean diameter | Mean diameter |
| | Polydispersity | Polydispersity |
| Examples | Zeta potential | Zeta potential |
| Example 1 | 50 nm | 51 nm |
| | 0.091 | 0.075 |
| | n/d | n/d |
| Example 3 | 37 nm | 39 nm |
| | 0.060 | 0.077 |
| | n/d | n/d |
| Example 4 | 41 nm | 47 nm |
| | 0.055 | 0.026 |
| | n/d | n/d |
| Example 6a | 35 nm | 35 nm |
| | 0.053 | 0.066 |
| | 3.69 mV measured at pH | 5.15 mV measured at pH |
| | 6.2 | 6.5 |
| Example 6b | 35 nm | 34 nm |
| | 0.034 | 0.116 |
| | 13.0 mV measured at pH | −22.2 mV measured at pH |
| | 6.2 | 6.5 |
| Example 6c | 33 nm | 38 nm |
| | 0.077 | 0.035 |
| | 13.7 mV measured at pH | −25.0 mV measured at pH |
| | 6.2 | 6.5 |

Test of Permeation

We describe here the manufacture of a cartridge enabling a fluid to percolate through a cylindrical core of porous rock in the longitudinal direction, without loss of fluid through the side thereof and the permeation of particles.

The equipment used is composed of the core, two plugs of the same diameter specially machined to enable the screwing of connectors, transparent PVC tube, a PTFE template, Araldite glue and a tube of commercial silicone sealant.

Insert one of the two plugs in the template, fix it with the silicone, then leave to dry for 30 minutes. Prepare the Araldite glue in an aluminum cup, then place the core on the plug and glue it, leave to dry for several minutes. Do the same for the top plug. Cutting out PVC tube to the corresponding length, put the silicone on the base of the tube then turn it over on the template. Put the whole thing into the oven at 50° C. for ½ hour.

Determine the volume of epoxy resin taking account of the phenomenon of imbibition in the rock (volume equivalent to 0.4 cm diameter of the column) The epoxy resin is composed of 70% of a resin base (Epon 828—Miller-Stephenson Chemical Company, Inc) and 30% of a hardener (Versamid 125—Miller-Stephenson Chemical Company, Inc). In a single-use plastic beaker, mix the resin with the hardener for 10 minutes, then place the mixture at 50° C. for 40 to 50 minutes until a transparent fluid mixture is obtained. Pour the mixture slowly along the PVC tube, then leave at ambient temperature for two hours. Then place the whole thing at 70° C. for two hours. Leave to cool at ambient temperature.

A synthetic sea water solution is composed of mineral water (containing 35 ppm of dissolved SiO₂) in which the following salts are dissolved:

| Salts | Concentration (g/l) |
|---|---|
| NaCl | 24.80 |
| KCl | 0.79 |
| MgCl₂ | 5.25 |
| CaCl₂ | 1.19 |
| NaHCO₃ | 0.10 |
| Na₂SO₄ | 4.16 |

A known quantity of potassium iodide is added to this solution—the iodide ion having an ideal tracer behavior for the permeation tests—in such a way as to have a concentration of 1 g/L in KI. The whole mixture is degassed by active stirring in a vacuum for 5 to 10 minutes.

Concentrated suspensions of nanoparticles in water or in diethylene glycol (DEG) are available, according to the preceding examples. A known quantity of these suspension is diluted in the preceding solution at a volume of 300 to 500 mL in such a way it has a concentration of particles between 0.1 and 10 mg/L. The suspension is left to be stirred gently for 10 minutes, then filtered on a membrane of 0.2 nm.

The assembly is composed of a double syringe pump which makes it possible to fix a flow rate of between 1 and 1000 mL per hour, typically between 20 and 100 mL per hour. This directs a fluid towards a cartridge containing the porous rock. The fluid percolates through this latter, the pressure differential on either side of the rock is tracked by a sensor. Finally, the fluid is directed towards a fraction collector.

In the case of a permeation of particles, the fluid used is a dilute suspension of particles and KI. In the case of washing of the rock or a test of desorption of particles after permeation, the fluid injected is degassed sea water without tracers.

In these fractions, on the one hand the UV absorption is measured at λ=254 nm of the fluid. This is very low when the fluid does not contain any iodide, and becomes substantial in the presence thereof. Therefore the UV absorption makes it possible to track the permeation of the ideal tracer. On the other hand, the fluorescence of the fractions is measured in conditions which make it possible to detect the fluorophore(s) present in the particles. Therefore this technique makes it possible to track the permeation of the particles.

The rock has the following characteristics:

### Type: Bentheimer

Nature of the material: sandstone, with clays (<5%).
Dimensions: 5 cm in diameter; 12.5 cm in length
Permeability: 800 mD approximately

### Porosity: 20%

Particles used, prepared according to Example 4.

The flow rate imposed by the pump is 60 mL/hour. The fractions collected at the rock outlet have a volume of 5 mL.

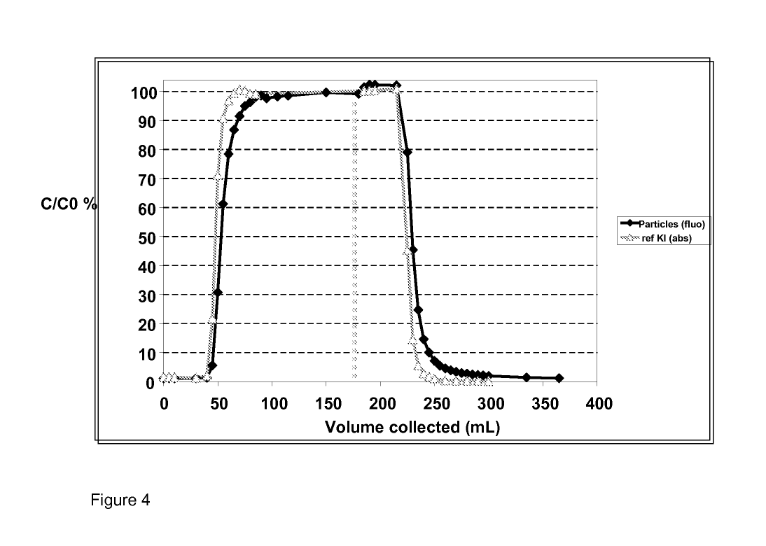

FIG. 4 shows a permeation curve of nanoparticles prepared according to the method of preparation 4 (comprising a step of heating to 80° C. for 1 hour) by comparison with the control KI (ideal tracer). The results of permeation show that the nanoparticles according to the invention can be easily used as tracers in injection waters. In fact a very good correlation is observed between the fluorescent nanoparticulate tracers and the ideal tracer taken as a reference (KI). In particular, a rate of passage of nanoparticles greater than 99% is obtained with a mean deviation with respect to the ideal tracer of less than 10%. As far as the inventors know, such results had not been obtained with nanoparticles having fluorophores detectable by time-resolved fluorescence, prepared by the methods according to the prior art.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A plurality of nanoparticles for use in the study of an oil reservoir, said nanoparticles comprising:
a core consisting of a noble metal or an alloy of noble metals; and
a matrix having a surface, said matrix comprising polysiloxanes and an organometallic fluorophore bound covalently to the polysiloxanes, said matrix being functionalized on said surface in order to form silane bonds Si—R, wherein at least 50% of said radicals —R consist of neutral or charged hydrophilic compounds.

2. The nanoparticles of claim 1, wherein said core consisting essentially of particles of gold.

3. The nanoparticles of claim 1, wherein said nanoparticles have a mean diameter of less than 100 nm and a polydispersity index of less than 0.3.

4. The nanoparticles of claim 1, wherein said organometallic fluorophore is chosen from lanthanides, alloys, and mixtures thereof, wherein said lanthanides being bound to at least one complexing molecule.

5. The nanoparticles of claim 4, wherein said complexing molecule has a co-ordinance of at least 6 and a dissociation constant pKd greater than 10.

6. The nanoparticles of claim 1, wherein said matrix of the nanoparticles is functionalized in such a way that the zeta potential of the nanoparticles, measured at a pH of 6.5 is less than +10 mV.

7. The nanoparticles of claim 1, wherein at least 50% of said radicals —R of said silanes Si—R on said surface consist of neutral hydrophilic radicals.

8. The nanoparticles of claim 7, wherein the neutral hydrophilic radicals are chosen from polyols, polyethers, or mixtures thereof.

9. The nanoparticles of claim 1, wherein said radicals —R of said silane bonds are present on said surface in a proportion of at least one radical —R per 10 nm² of said surface.

10. A method of preparation of a colloidal solution of nanoparticles which can be used as tracers for the study of an oil reservoir, said method comprising:
synthesizing a noble metal core coated with a matrix of polysiloxane prefunctionalized with hydrophilic silanes, within a reverse microemeulsion;
extracting an aqueous colloidal solution of nanoparticles by decantation after destabilization of the microemulsion; and
heating the nanoparticles to at least 50° C.

11. The method of claim 10, said nanoparticles are never in a solid dry phase during the course of said method.

12. The method of claim 10, further comprising washing said aqueous colloidal solution of nanoparticles after said extracting step.

13. The method of claim 10, further comprising transferring said colloidal solution of nanoparticles into a non-aqueous solvent before said heating step.

14. The method of claim 10, further comprising post-functionalizing said matrix of said nanoparticles in the presence of a non-aqueous solvent before or after said heating step.

15. The method of claim 14, further comprising filtering said aqueous colloidal solution of nanoparticles obtained after said heating step, said post-functionalizing step, or both said heating and said post-functionalizing steps.

16. A colloidal solution of nanoparticles capable of being obtained by said method as claimed in claim 10.

17. The colloidal solution of nanoparticles as claimed in claim 16, wherein said nanoparticles comprise:
a core consisting of a noble metal or an alloy of noble metals; and
a matrix having a surface, said matrix comprising polysiloxanes and an organometallic fluorophore bound covalently to the polysiloxanes, said matrix being functionalized on said surface in order to form silane bonds Si—R, wherein at least 50% of said radicals —R consist of neutral or charged hydrophilic compounds.

18. An injection liquid for the study of an oil reservoir, said injection liquid comprising said colloidal solution as claimed in claim 17.

19. A use of said nanoparticles as defined in claim 1 as tracers in injection waters of an oil reservoir, which are intended for the study of said reservoir by diffusion therethrough, for the purpose in particular of monitoring the flows between an injection well and a production well and/or evaluating the volumes of oil in reserve in the reservoir.

20. The nanoparticles of claim 1, wherein said neutral or charged hydrophilic compounds are chosen from polyethers, polyols, or mixtures thereof.

21. The method of claim 12, wherein said colloidal solution of nanoparticles is washed after the extracting step by tangential filtration.

22. An injection liquid for the study of an oil reservoir comprising said colloidal solution as claimed in claim 16.
